(19) United States
(12) Patent Application Publication
(10) Pub. No.: US 2026/0094117 A1
(43) Pub. Date: Apr. 2, 2026

(54) Real Estate Networking and Information Aggregation App

(71) Applicant: Zhara Michelle Fernandez, Nashville, TN (US)

(72) Inventor: Zhara Michelle Fernandez, Nashville, TN (US)

(21) Appl. No.: 18/898,758

(22) Filed: Sep. 27, 2024

(51) Int. Cl. G06Q 10/10; G06F 16/93; G06Q 30/018; G06Q 50/163

(52) U.S. Cl. CPC G06Q 10/10; G06F 16/93; G06Q 30/018; G06Q 50/163

(57) ABSTRACT

The present invention relates to a real estate networking and information aggregation application, Real Estate Networking and Information Aggregation App. The system provides comprehensive data aggregation from various online sources, member registration and profile creation tailored to specific roles, license verification for credibility, and robust networking and communication tools. Real Estate Networking and Information Aggregation App addresses the fragmentation of real estate information and facilitates seamless transaction coordination among industry professionals.

### CROSS-REFERENCE TO RELATED APPLICATIONS

Nil.

### STATEMENT REGARDING FEDERALLY SPONSORED RESEARCH OR DEVELOPMENT

Nil.

### BACKGROUND OF THE INVENTION

The present invention relates to computer systems for managing real estate information and processes, specifically an application designed to aggregate real estate information, facilitate networking, and coordinate transactions among various real estate industry professionals.

### DESCRIPTION OF THE RELATED ART

Existing real estate management systems often lack integration and efficiency, failing to provide comprehensive networking opportunities and robust data aggregation. Current platforms like Zillow, Realtor. com, and Redfin focus primarily on property listings without extensive networking features. LinkedIn, although a networking platform, does not cater specifically to the real estate industry nor does it facilitate transactions. This invention addresses these gaps by offering a centralized platform that aggregates information and connects industry professionals.

### SUMMARY OF THE INVENTION

The present invention, Real Estate Networking and Information Aggregation App, provides a comprehensive real estate networking and information aggregation application. The application addresses the fragmentation of real estate information and the lack of a centralized platform for industry professionals to connect, share information, and coordinate transactions. Key features include:
Aggregation of real estate information from various online sources.
Member registration and profile creation tailored to specific roles.
Verification of licenses for realtors and contractors.
Communication and networking tools for members.
Submission and viewing of property details.

### BRIEF DESCRIPTION OF THE DRAWINGS

FIG. 1: System architecture of Real Estate Networking and Information Aggregation App.

FIG. 2: User registration and profile creation flowchart.

FIG. 3: Data aggregation process.

FIG. 4: Property submission and listing interface.

FIG. 5: License verification process.

FIG. 6: Networking and communication tools interface. FIG. 7: Example user interaction within the app.

### DETAILED DESCRIPTION OF THE INVENTION

### Overview

Real Estate Networking and Information Aggregation App is designed to aggregate real estate information from various online sources and connect real estate industry professionals, including investors, flippers, licensed realtors, wholesalers, buyers, sellers, contractors, and developers. The system facilitates networking, information sharing, and transaction coordination among these members.

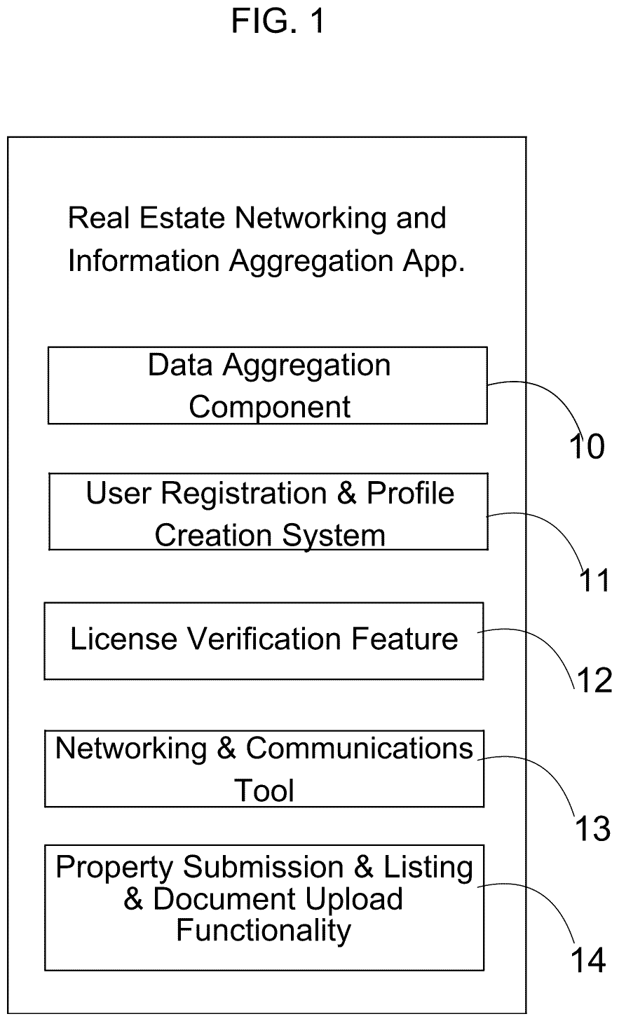

FIG. 1 discloses the system architecture of the present invention and it includes the following major components:
1. Data Aggregation Component (10):
Aggregates real estate information from multiple online sources, including property details, market trends, investment opportunities, and industry news.
Utilizes data aggregation scripts and APIs to pull information from various real estate websites.
2. User Registration and Profile Creation System (11):
Allows members to register and create profiles tailored to their specific roles (e.g., investor, flipper, realtor, buyer, seller, contractor, developer).
Users provide relevant details and preferences during profile creation.
3. License Verification Feature (12):
Licensed professionals, such as realtors and contractors, must provide and verify their license numbers during registration.
Ensures credibility and trust among users.
4. Networking and Communication Tools (13):
Enables communication and networking among members via in-app messaging.
Users can schedule viewings, negotiate deals, and share information directly through the platform.
5. Property Submission, Listing Functionality and Document and Photo Upload Capabilities (14):
Users can submit property listings, upload documents and photos, and specify location and budget preferences.
Facilitates the submission and viewing of detailed property information.
Allows users to upload and manage documents and photos related to property listings and transactions.

### Process Flow

1. Data Aggregation:
The app gathers data related to real estate properties, market trends, investment opportunities, and industry news from multiple online platforms using data aggregation scripts and APIs.
2.User Registration and Profile Creation:
Users register on the app and create profiles based on their roles (e.g., investor, flipper, realtor, buyer, seller, contractor, developer).
Licensed professionals must provide and verify their license numbers during the registration process.
3. Property Submission and Listing:
Users submit property listings by providing detailed information, uploading documents and photos, and specifying location and budget preferences.
Property details are stored in a searchable database accessible by other users.
4. Networking and Communication:
Users can communicate via in-app messaging, schedule viewings, and negotiate deals directly through the platform.
The app facilitates networking by connecting users based on their roles and needs.
5. License Verification:
The system verifies the licenses of realtors and contractors during the registration process to ensure credibility and trust among users.
6. Transaction Coordination:
The app coordinates transactions by enabling users to submit offers, respond to offers, and finalize deals.
Documents and agreements can be managed and signed digitally within the platform.

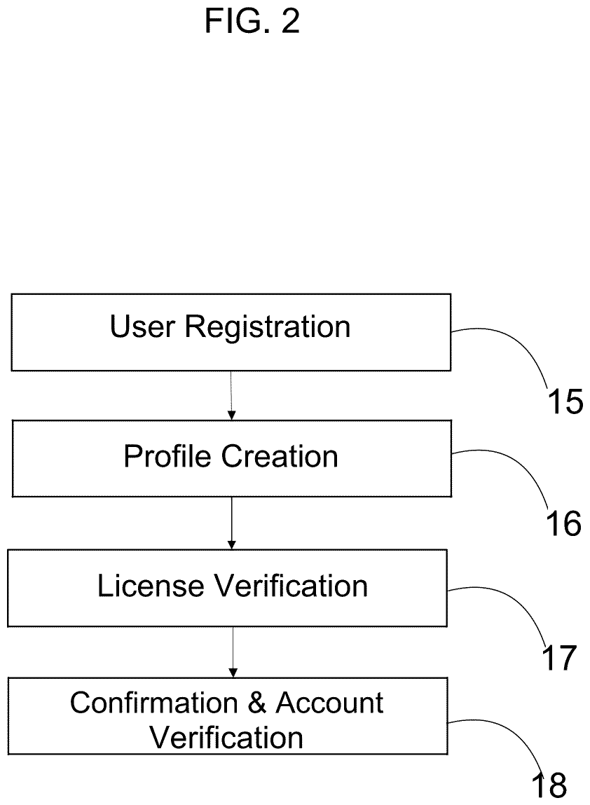

FIG. 2 shows the user account creation process which includes user registration (15), profile creation (16), license verification (17) and confirmation and account verification (18).

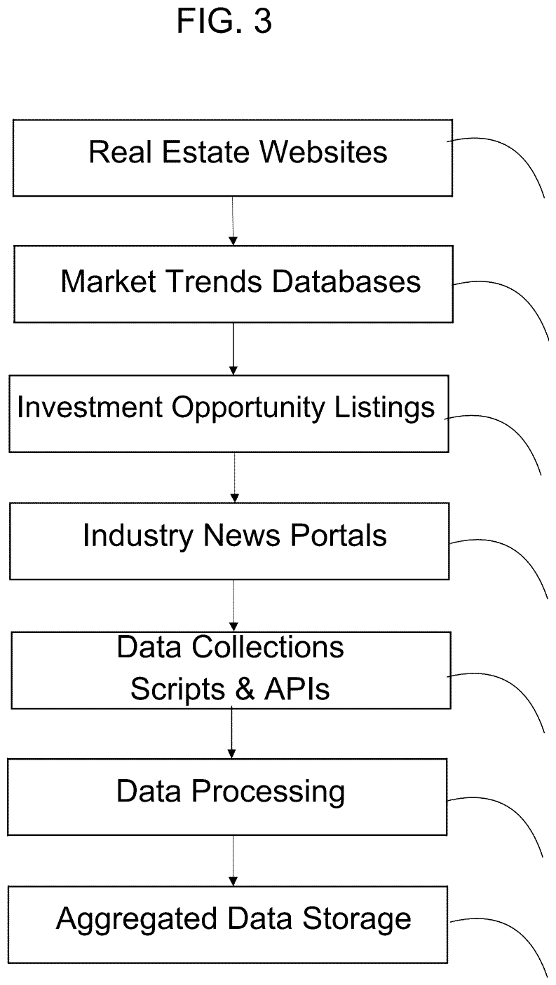

FIG. 3 includes the sources from which real estate related data are gathered from. These sources include real estate websites (19), market trends databases (20), investment opportunity listings (21), industry news portals (22), scripts/APIs (23). The compiled date is processed (24), aggregated and stored (25).

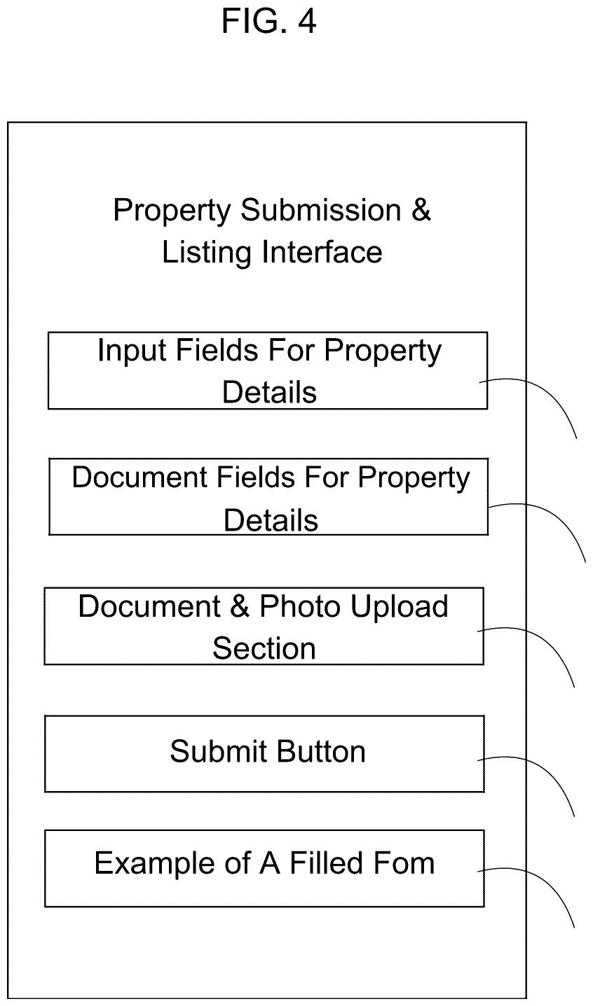

FIG. 4 illustrates the property submission and listing interface. It comprises the input fields for property details (26), document fields for property details (27), document and photo upload section (28), the submit button (29) and an example of a filled form (30) for this interface.

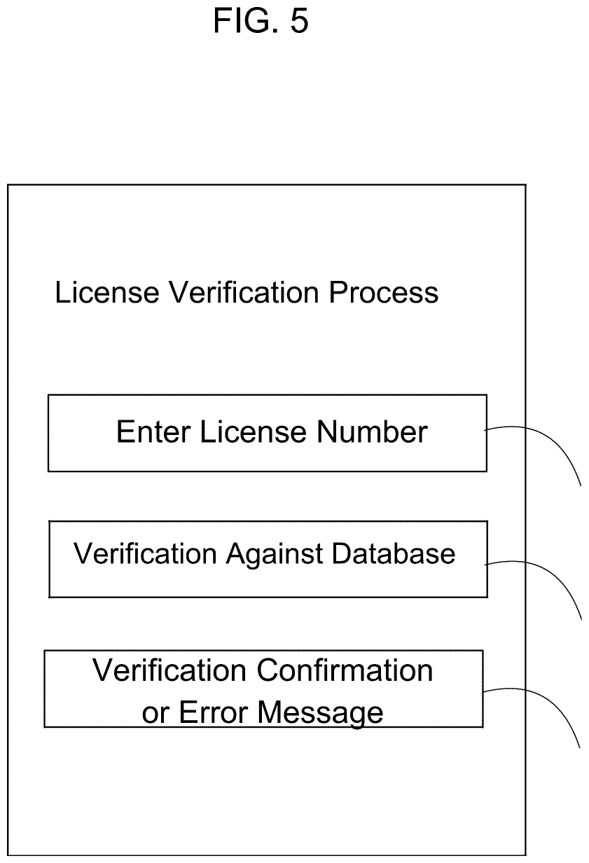

FIG. 5 demonstrates the license verification process for realtors and it includes Entering the license number (32), verification against the database (33) and a Verification confirmation or error message (34).

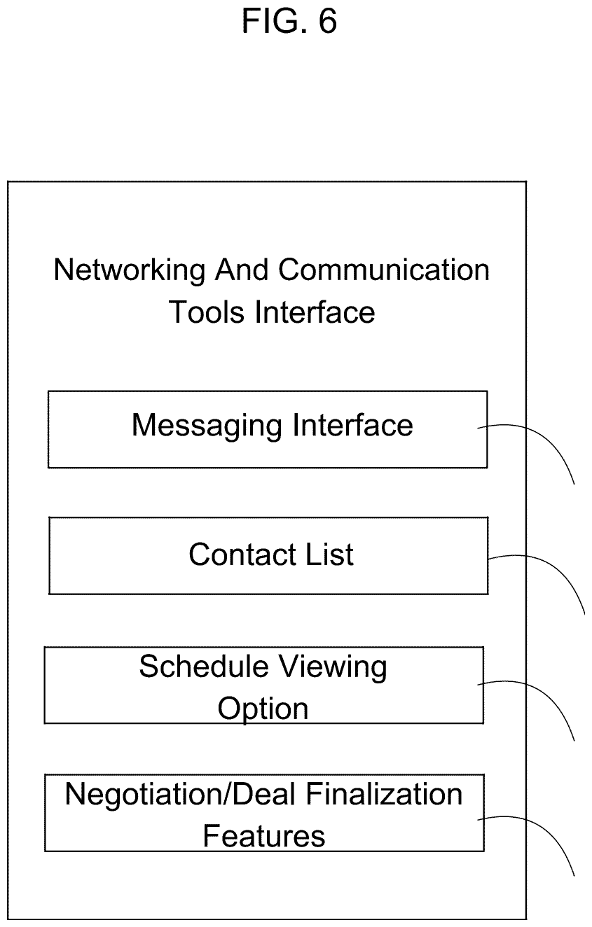

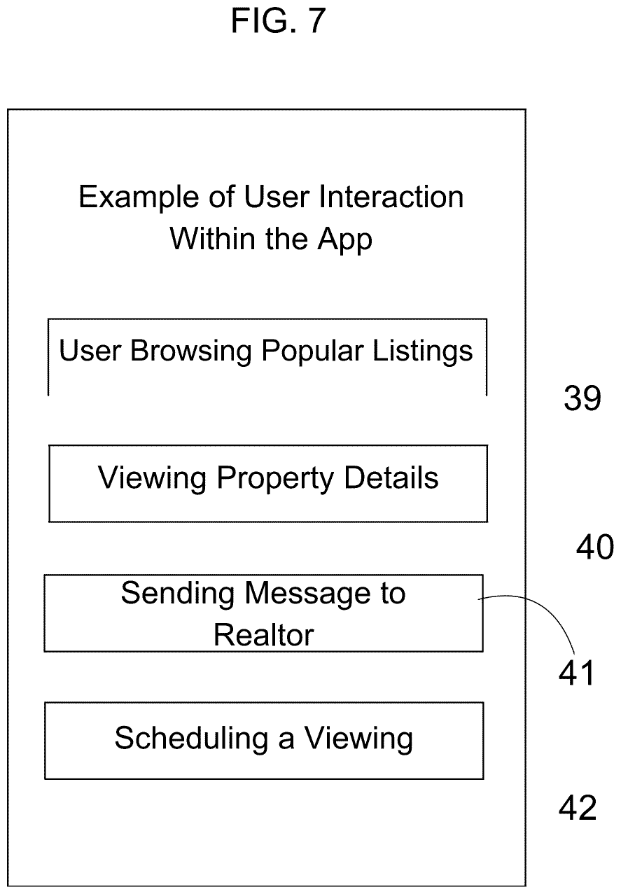

FIG. 6 illustrates the networking and communication tools interface for the present invention. It includes a messaging interface (35), a contact list (36), an option to view schedules (37) and Negotiation/deal finalization features (38).

### Implementation Examples

An investor using Real Estate Networking and Information Aggregation App to browse (39) investment opportunities, views property details (40), messages realtor (41) submit offers, and engage with licensed realtors and contractors for property inspections.

### Advantages of the Invention

1. Comprehensive aggregation of real estate information from multiple sources, providing a holistic view of the market.
2. Tailored profiles and networking features enable professionals to connect and collaborate more effectively.
3. License verification ensures credibility and trust among users.
4. Facilitates seamless transaction coordination and document management.

### Definition List for Industry Specific Terms

1. API: Application Programming Interface, a set of tools and protocols for building software applications and enabling interaction between different software systems.
2. Data Aggregation: The process of collecting and summarizing data from multiple sources to provide a comprehensive view.
3. Digital Document Management: The use of software to store, manage, and track electronic documents and images of paper-based information.
4. License Verification: The process of checking the validity of professional licenses to ensure that individuals meet required standards.
5. Networking: The act of connecting with other professionals to share information, collaborate, and build relationships.
6. Profile Creation: The process of setting up a user account and providing personal and professional information to be displayed on a platform.
7. Real Estate Transaction: The process of buying, selling, or leasing real estate property.

1. A method for managing real estate transactions, comprising:
I. Aggregating real estate information from various online sources;
II. Registering members and creating profiles tailored to their roles;
III. Verifying licenses for realtors and contractors;
IV. Enabling communication and networking among members;
V. Facilitating the submission and viewing of property details.

2. The method of claim 1, wherein the system verifies the licenses of realtors and contractors during the registration process.

3. The method of claim 1, wherein the system allows users to upload and manage documents and photos related to property listings.

4. A system for real estate management, comprising:
I. A data aggregation component for gathering real estate information from multiple online sources;
II. A user registration and profile creation system tailored to specific roles;
III. A license verification feature for ensuring credibility;
IV. Networking and communication tools for member interaction;
V. Property submission and listing functionality.

5. The system of claim 4, wherein the system includes a module for digital document management and signing.

6. The system of claim 4, wherein the system integrates with external real estate websites and APIs for data aggregation.
